(19) United States
(12) Patent Application Publication
(10) Pub. No.: US 2025/0192419 A1
(43) Pub. Date: Jun. 12, 2025

(54) CONNECTION STRUCTURE AND ELECTRONIC DEVICE

(71) Applicant: Wistron NeWeb Corporation, Hsinchu (TW)

(72) Inventors: Yu-Kai CHIU, Hsinchu (TW); Po-Yuan CHANG, Hsinchu (TW)

(21) Appl. No.: 18/758,121

(22) Filed: Jun. 28, 2024

(30) Foreign Application Priority Data
Dec. 8, 2023 (TW) 112147779

(51) Int. Cl. H01Q 1/22; H01Q 1/02; H01Q 1/52

(52) U.S. Cl. CPC H01Q 1/2291; H01Q 1/02; H01Q 1/521

(57) ABSTRACT

A connection structure has an extension direction and includes a fitting part, a fixing part, and a turning part. The fitting part includes two joint surfaces. The fixing part includes a surface. The turning part is connected between the fitting part and the fixing part, and the turning part is inclined relative to the fitting part and the fixing part. One of the two joint surfaces of the fitting part faces a same direction as the surface of the fixing part. An offset distance is between one of the two joint surfaces and the surface along a direction vertical to the extension direction. Thus, the connection structure of the present disclosure can prevent two different antenna modules in the electronic device from interfering with each other.

### RELATED APPLICATIONS

This application claims the benefit of priority to Taiwan Patent Application Serial No. 112147779, filed on Dec. 8, 2023. The entire content of the above identified application is incorporated herein by reference.

### BACKGROUND

### Technical Field

The present disclosure relates to a bracket structure, and in particular to a bracket structure and an antenna fixing device that can avoid mutual influence between two antenna modules.

### Description of Related Art

In general products where a Wi-Fi antenna and a Digital Enhanced Cordless Telecommunications (DECT) antenna coexist, the DECT antenna needs to be as far away from the Wi-Fi antenna as possible. If the DECT antenna is located too close to the Wi-Fi antenna, due to insufficient antenna clearance area between the DECT antenna and the Wi-Fi antenna, they will interact with each other and reduce the antenna efficiency.

In the design of the DECT antenna position, if the Wi-Fi antenna and the DECT antenna are to be placed on the same base, the base needs a huge volume to keep the DECT antenna and the Wi-Fi antenna as far away as possible. However, the large base is not complied with cost considerations. If the DECT antenna is placed on the heat dissipation structure of the product, although it can be far away from the Wi-Fi antenna, being too close to the heat dissipation structure will also cause the DECT antenna characteristics to be affected by the metal parts of the heat dissipation structure.

In view of this, there is currently a lack of a structure in the market that can make one of the antenna modules away from the other antenna module and metal parts at the same time when two different antenna modules coexist, so the relevant industry is looking for its solution.

### SUMMARY

According to one embodiment of the present disclosure, a connection structure having an extension direction is provided. The connection structure includes a fitting part, a fixing part, and a turning part. The fitting part includes two joint surfaces. The fixing part includes a surface. The turning part is connected between the fitting part and the fixing part, and the turning part is inclined relative to the fitting part and the fixing part. One of the two joint surfaces of the fitting part faces a same direction as the surface of the fixing part, and an offset distance is between one of the two joint surfaces and the surface along a direction vertical to the extension direction.

According to another embodiment of the present disclosure, an electronic device is provided. The electronic device includes a first antenna module, a communication base, a heat dissipation structure, a second antenna module, and a connection structure. The communication base is configured for the first antenna module to be disposed. The heat dissipation structure is disposed below the communication base. The second antenna module is disposed below the first antenna module and is disposed on one side of the heat dissipation structure. A first distance is between the second antenna module and the first antenna module, and a second distance is between the second antenna module and the heat dissipation structure. The connection structure has an extension direction. The connection structure is configured to detachably connect the second antenna module and the communication base along the extension direction. The connection structure includes a fitting part, a fixing part, and a turning part. The fitting part includes two joint surfaces. The fixing part includes a surface. The turning part is connected between the fitting part and the fixing part, and the turning part is inclined relative to the fitting part and the fixing part. One of the two joint surfaces of the fitting part faces a same direction as the surface of the fixing part, and an offset distance is between the one of the two joint surfaces and the surface along a direction vertical to the extension direction.

### BRIEF DESCRIPTION OF THE DRAWINGS

The present disclosure can be more fully understood by reading the following detailed description of the embodiment, with reference made to the accompanying drawings as follows:

FIG. 1 is a schematic view of an electronic device according to an embodiment of the present disclosure.

FIG. 2 is a partial enlarged view of the electronic device according to the embodiment of FIG. 1.

FIG. 3 is a three-dimensional schematic view of a connection structure according to the embodiment of FIG. 1.

FIG. 4 is a front view of the connection structure according to FIG. 3.

FIG. 5 is a bottom view of a communication base according to the embodiment of FIG. 1.

FIG. 6 is a schematic view of the connection between a fitting part of the connection structure and a socket structure of the communication base according to the embodiment of FIG. 1.

FIG. 7 is a schematic view of a second antenna module fixed by a fixing part of the connection structure according to the embodiment of FIG. 1.

FIG. 8 is another schematic view of the second antenna module fixed by the fixing part of the connection structure according to the embodiment of FIG. 1.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

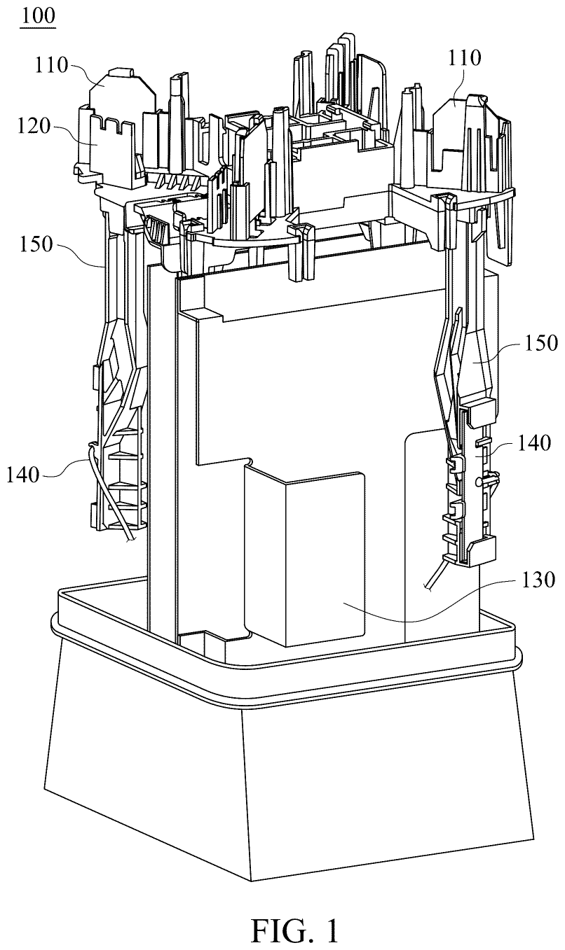

Referring to FIG. 1. FIG. 1 is a schematic view of an electronic device 100 according to an embodiment of the present disclosure. The electronic device 100 includes two first antenna modules 110, a communication base 120, a heat dissipation structure 130, two second antenna modules 140, and two connection structures 150. The heat dissipation structure 130 is disposed on a base (reference number is omitted) and is disposed below the communication base 120. The communication base 120 is configured for the first antenna module 110 to be disposed on. The second antenna module 140 is detachably connected to the communication base 120 through the connection structure 150. Each of the second antenna modules 140 are respectively disposed below each of the first antenna modules 110, and are respectively disposed on two sides of the heat dissipation structure 130. In the embodiment of FIG. 1, the first antenna module 110 can be a Wi-Fi antenna, and the second antenna module 140 can be a Digital Enhanced Cordless Telecommunications (DECT) antenna, but the present disclosure is not limited thereto. It is noted that the electronic devices in other embodiments of the present disclosure, the number of the first antenna modules and the second antenna modules may be one or more than three respectively, and may be disposed on the same side of the electronic device in pairs, and is not limited to FIG. 1. Subsequent descriptions will be given of the first antenna module 110 and the second antenna module 140 corresponding to the same side.

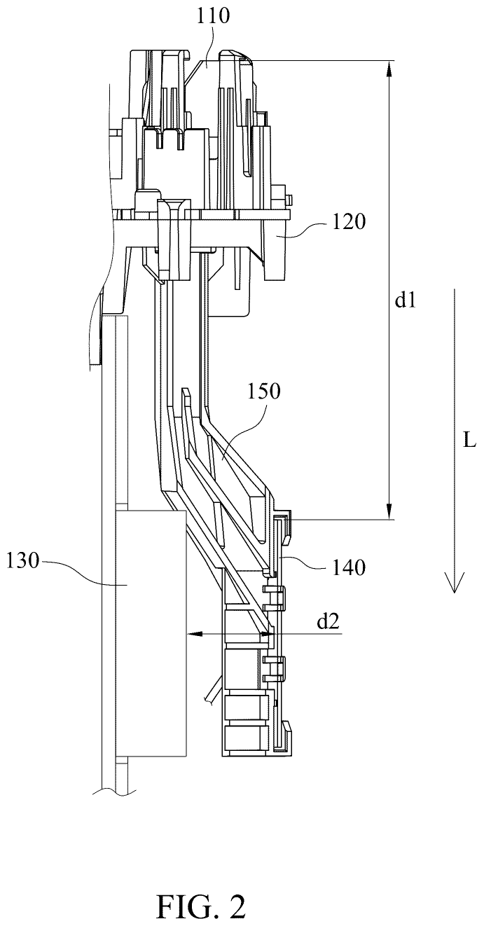

Referring to FIG. 1 and FIG. 2. FIG. 2 is a partial enlarged view of the electronic device 100 according to the embodiment of FIG. 1. A first distance d1 is between the second antenna module 140 and the first antenna module 110. A second distance d2 is between the antenna module 140 and the heat dissipation structure 130. Specifically, the first distance d1 can be at least 30 mm. The second distance d2 can be at least 10 mm. More specifically, the first distance d1 can be between 60 mm and 70 mm. The second distance d2 can be between 20 mm and 25 mm.

Therefore, it helps to increase the antenna clearance area of the second antenna module 140 and avoids interference between the second antenna module 140 and the first antenna module 110, which affects the antenna efficiency. It also avoids metal parts of the heat dissipation structure 130 affecting the radiation characteristics of the second antenna module 140. In addition, the second antenna module 140 is designed on the connection structure 150 to be detachably connected to the communication base 120, which can greatly reduce the volume of the communication base 120, thereby reducing the unit price of parts and molding costs.

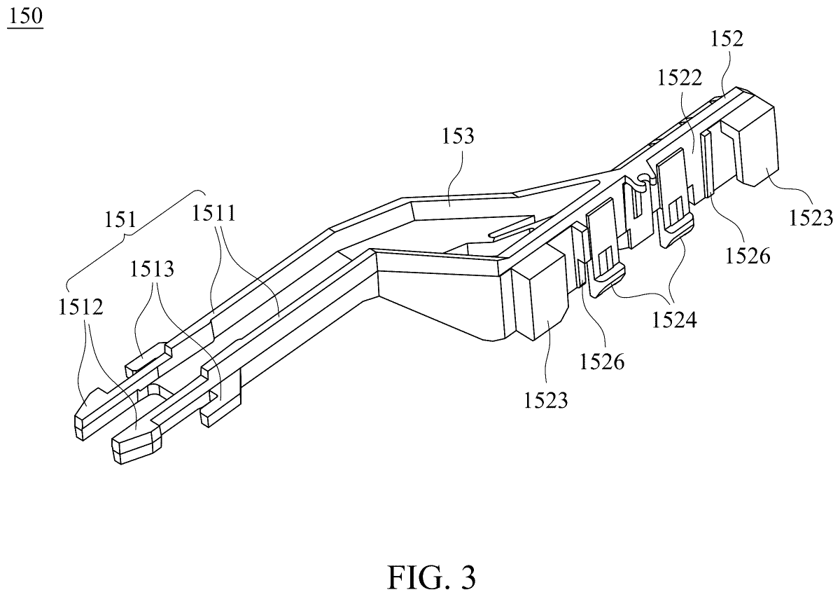

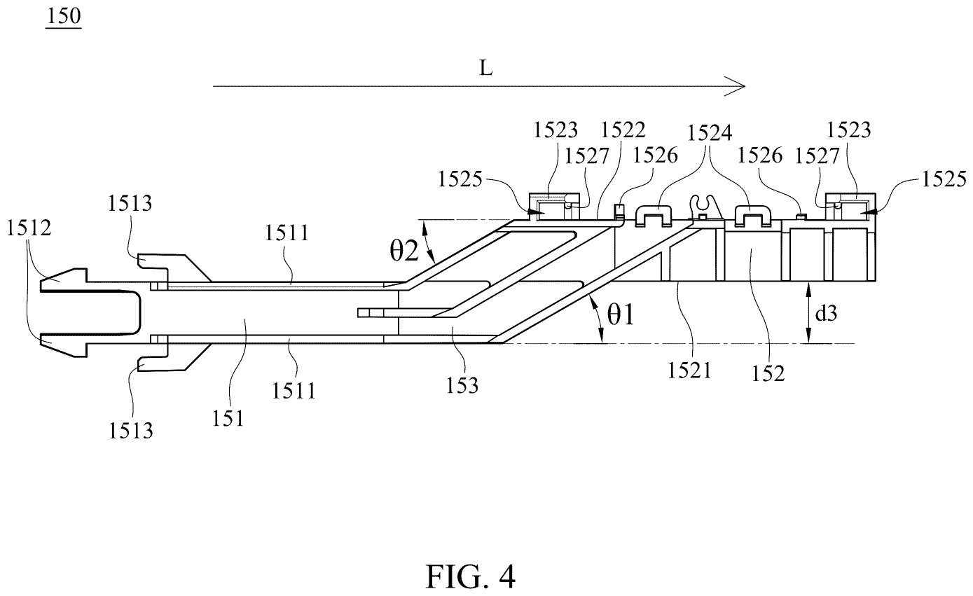

Referring to FIG. 1 to FIG. 4 for further explanations. FIG. 3 is a three-dimensional schematic view of the connection structure 150 according to the embodiment of FIG. 1. FIG. 4 is a front view of the connection structure 150 according to FIG. 3. The connection structure 150 is in the shape of lightning (Qoppa Z-shaped) and has an extension direction L. The connection structure 150 is configured for detachably connect to the second antenna module 140 and the communication base 120 along the extension direction L, resulting in the second antenna module 140 being separated from the first antenna module 110 by the first distance d1 and separated from the heat dissipation structure 130 by the second distance d2. The first distance d1 is approximately parallel to the extension direction L, and the second distance d2 is approximately perpendicular to the extension direction L.

The connection structure 150 includes a fitting part 151, a fixing part 152, and a turning part 153. The turning part 153 is connected between the fitting part 151 and the fixing part 152, and is inclined relative to the fitting part 151 and the fixing part 152. The fitting part 151 is configured to be detachably connected to the communication base 120 along the extension direction L. The fixing part 152 is configured to fix the second antenna module 140. In the embodiment of FIG. 3, the fitting part 151, the fixing part 152, and the turning part 153 are integrally formed.

The fitting part 151 includes two joint surfaces 1511. The fixing part 152 includes a surface 1521. One of the two joint surfaces 1511 faces the same direction as the surface 1521. An offset distance d3 is between the joint surface 1511 and the surface 1521 along a direction vertical to the extension direction L. Specifically, the turning part 153 is inclined at a first angle θ1 relative to the fitting part 151 towards the fixing part 152, and is inclined at a second angle θ2 relative to the fixing part 152 towards the fitting part 151. By inclining the two-step deflection structure in which the turning part 153 is inclined at the first angle θ1 and the second angle θ2, an offset distance d3 can be generated between the joint surface 1511 and the surface 1521, so that when the second antenna module 140 is fixed to the fixing part 152, it can maintain a distance from the heat dissipation structure 130. In the embodiment of FIG. 4, the first angle θ1 is equal to the second angle θ2. The surface 1521 is parallel to the joint surface 1511. The offset distance d3 can be between 3 mm and 50 mm, such as about 8.67 mm, but the present disclosure is not limited thereto. Without considering the rest of the factors such as the overall configuration, the offset distance d3 can be increased to obtain better antenna isolation.

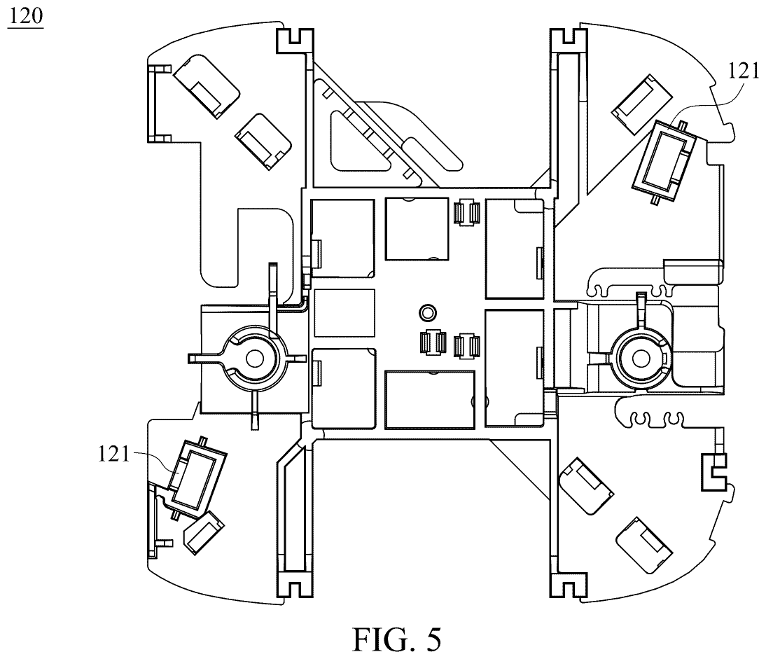

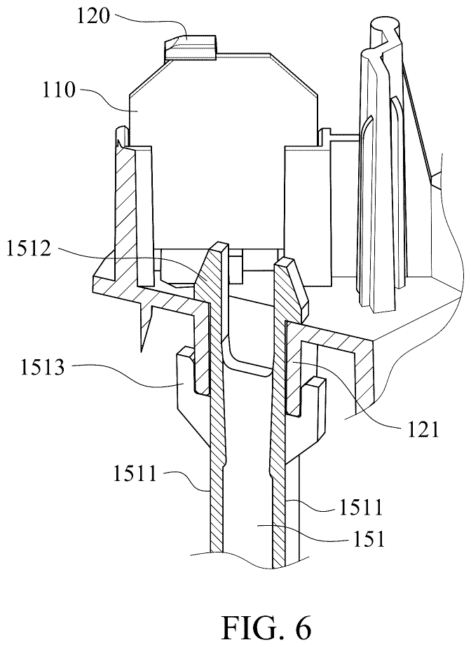

Referring to FIG. 1 and FIG. 3 to FIG. 6. FIG. 5 is a bottom view of the communication base 120 according to the embodiment of FIG. 1. FIG. 6 is a schematic view of the connection between the fitting part 151 of the connection structure 150 and the socket structure 121 of the communication base 120 according to the embodiment of FIG. 1. The communication base 120 includes two socket structures 121 (as shown in FIG. 5) configured to be fastened by the fitting part 151. It is noted that, the number of socket structures 121 corresponds to the number of the connection structures 150. The number of the socket structures may be one or more than three in the electronic device in other embodiments of the present disclosure, and is not limited to FIG. 5. The fitting part 151 can further include two engagement portions 1512 and at least one restrictive portion 1513. The engagement portion 1512 is connected to an end of the joint surface 1511 away from the turning part 153. At least one restrictive portion 1513 is connected to at least one of the two joint surfaces 1511, and is adjacent to at least one of the two engagement portions 1512. In the embodiment of FIG. 3, the number of the restrictive portions 1513 is two, but the present disclosure is not limited thereto. As shown in FIG. 6, the engagement portion 1512 corresponds to the socket structure 121 of the communication base 120. The engagement portion 1512 is configured to extend into and fasten the top of the socket structure 121, and is detachably connected to the second antenna module 140 and the communication base 120 along the extension direction L. When the engagement portion 1512 is fastened to the socket structure 121, the restrictive portion 1513 is configured to be embedded in two sides of the socket structure 121 to prevent the engagement portion 1512 from falling off from the socket structure 121 due to external force factors such as bending or shaking.

Therefore, the disassembly design of connecting the socket structure 121 of the communication base 120 through the fitting part 151 of the connection structure 150 can greatly reduce the complexity of the assembly operation of the second antenna module 140, thereby reducing the assembly man-hours and thus the assembly cost. In addition, by fastening the fitting part 151 on the socket structure 121, the connection structure 150 and the communication base 120 are assembled without the use of screws or gluing, making it easy to disassemble and facilitate recycling, which complies with the sustainable recycling goals of green design.

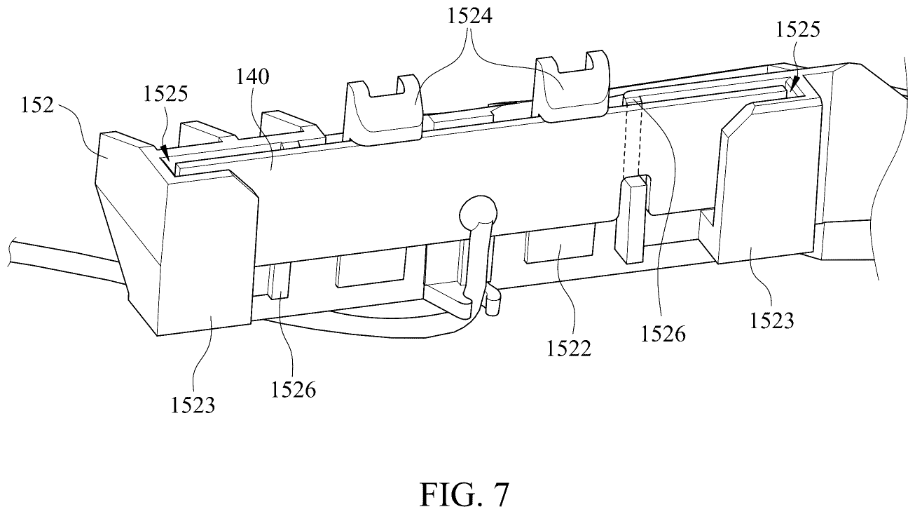

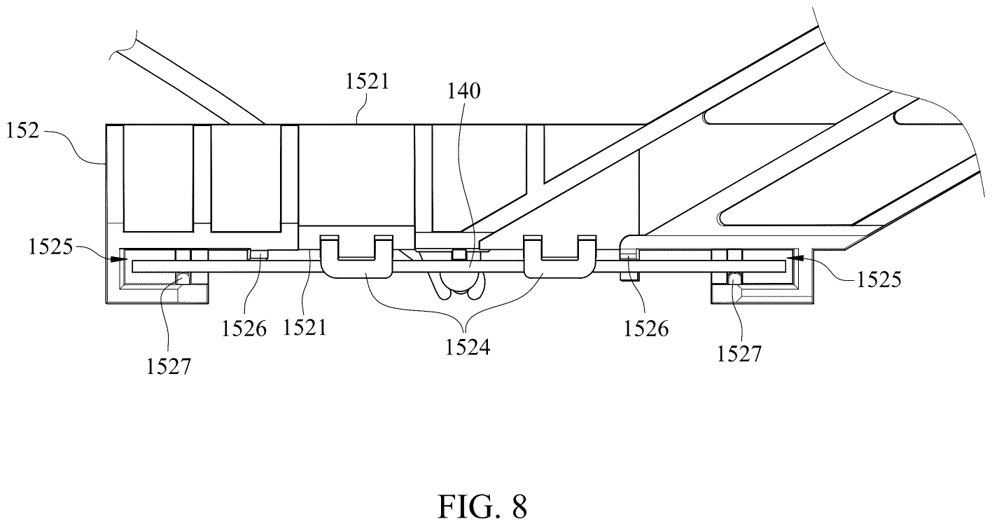

Referring to FIG. 1 to FIG. 4, FIG. 7 and FIG. 8. FIG. 7 is a schematic view of the second antenna module 140 fixed by the fixing part 152 of the connection structure 150 according to the embodiment of FIG. 1. FIG. 8 is another schematic view of the second antenna module 140 fixed by the fixing part 152 of the connection structure 150 according to the embodiment of FIG. 1. The fixing part 152 may further include a fixing surface 1522, two retaining walls 1523, at least one hook 1524, at least one first stop part 1526, and at least one second stop part 1527. The fixing surface 1522 is opposite to the surface 1521. The two retaining walls 1523 are connected to two ends of the surface 1521 respectively, and respectively form an accommodating groove 1525 with the fixing surface 1522. The at least one hook 1524 is disposed on the fixing surface 1522 and is between the two retaining walls 1523. The at least one first stop part 1526 is disposed on the fixing surface 1522. The at least one second stop part 1527 is disposed on the retaining wall 1523. In the embodiment of FIG. 3, the number of the at least one hook 1524, the number of the at least one first stop part 1526 and the number of the at least one second stop part 1527 are two, but the present disclosure is not limited thereto.

As shown in FIG. 7 and FIG. 8, the accommodating groove 1525 is configured to accommodate a substrate (reference number is omitted). The hook 1524 is configured to fix the second antenna module 140 to the accommodating groove 1525. The first stop part 1526 and the second stop part 1527 are configured to tighten the second antenna module 140. Specifically, the first stop part 1526 and the second stop part 1527 are disposed in pairs. The first stop part 1526 protrudes from the fixing surface 1522, and the second stop part 1527 protrudes from the retaining wall 1523 towards the fixing surface 1522. When the second antenna module 140 is accommodated in the accommodating groove 1525, the second antenna module 140 can be fastened and fixed in the accommodating groove 1525 through the hooks 1524. At the same time, the first stop part 1526 and the second stop part 1527 can clamp and slightly bend the substrate of the second antenna module 140 from opposite direction to press and tighten the second antenna module 140.

Therefore, the first stop part 1526 and the second stop part 1527 can clamp and slightly bend the second antenna module 140 from opposite directions through a micro-interference clamping pair design, thereby avoiding the shaking gap between the second antenna module 140 and the accommodating groove 1525 so as to prevent the second antenna module 140 from producing shaking noise, and thus maintaining the transmission quality of the second antenna module 140.

From the above embodiment, the connection structure and the electronic device provided by the present disclosure have the following advantages:

First, the antenna clearance area of the second antenna module can be increased through the connection structure, and the second antenna module is far away from the first antenna module and the heat dissipation structure at the same time, so that in addition to avoiding the interaction between the first antenna module and the second antenna module, the radiation characteristics of the antenna module can also be avoided from being affected by metal parts.

Second, by designing the second antenna module on the connection structure to detachably connect the communication base, the volume of the communication base can be greatly reduced, the unit price of parts and the molding costs can be reduced, and the complexity of the assembly operation of the second antenna module can be greatly reduced, thereby reducing the assembly man-hours and thus the assembly cost.

Third, the assembly of the connection structure and the communication base can be connected without the use of any fixing components (e.g., screws, backing adhesive, adhesive, or curing glue) and is also easy for users to disassemble and recycle, which is complied with the green design goal.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A connection structure having an extension direction, comprising:
a fitting part comprising two joint surfaces;
a fixing part comprising a surface; and
a turning part connected between the fitting part and the fixing part, and the turning part being inclined relative to the fitting part and the fixing part;
wherein one of the two joint surfaces of the fitting part faces a same direction as the surface of the fixing part, and an offset distance is between the one of the two joint surfaces and the surface along a direction vertical to the extension direction.

2. The connection structure according to claim 1, wherein the turning part is inclined at a first angle relative to the fitting part towards the fixing part, and is inclined at a second angle relative to the fixing part towards the fitting part.

3. The connection structure according to claim 2, wherein the first angle is equal to the second angle.

4. The connection structure according to claim 1, wherein the fixing part further comprises:
a fixing surface relative to the surface; and
two retaining walls respectively connected to two ends of the fixing surface, and respectively forming an accommodating groove with the fixing surface.

5. The connection structure according to claim 4, wherein the fixing part further comprises:
at least one hook disposed on the fixing surface and between the two retaining walls.

6. The connection structure according to claim 1, wherein the surface is parallel to the two joint surfaces.

7. The connection structure according to claim 1, wherein the fitting part further comprises:
two engagement portions connected to an end of the two joint surfaces away from the turning part; and
at least one restrictive portion connected to at least one of the two joint surfaces, and adjacent to at least one of the two engagement portions.

8. The connection structure according to claim 1, wherein the connection structure is in a shape of lightning.

9. An electronic device, comprising:
a first antenna module;
a communication base configured for the first antenna module to be disposed;
a heat dissipation structure disposed below the communication base;
a second antenna module disposed below the first antenna module and disposed on one side of the heat dissipation structure, wherein a first distance is between the second antenna module and the first antenna module, and a second distance is between the second antenna module and the heat dissipation structure; and
a connection structure having an extension direction, the connection structure being configured to detachably connect the second antenna module and the communication base along the extension direction, and comprising:
a fitting part comprising two joint surfaces;
a fixing part comprising a surface; and
a turning part connected between the fitting part and the fixing part, and the turning part being inclined relative to the fitting part and the fixing part;
wherein one of the two joint surfaces of the fitting part faces a same direction as the surface of the fixing part, and an offset distance is between the one of the two joint surfaces and the surface along a direction vertical to the extension direction.

10. The electronic device according to claim 9, wherein the turning part is inclined at a first angle relative to the fitting part towards the fixing part, and is inclined at a second angle relative to the fixing part towards the fitting part.

11. The electronic device according to claim 10, wherein the first angle is equal to the second angle.

12. The electronic device according to claim 9, wherein the fixing part further comprises:
a fixing surface relative to the surface; and
two retaining walls respectively connected to two ends of the fixing surface, and respectively forming an accommodating groove with the fixing surface, and the accommodating groove being configured to accommodate the second antenna module.

13. The electronic device according to claim 12, wherein the fixing part further comprises:
at least one hook disposed on the fixing surface and between the two retaining walls, and the at least one hook being configured to fix the second antenna module in the two accommodating grooves.

14. The electronic device according to claim 9, wherein the surface is parallel to the two joint surfaces.

15. The electronic device according to claim 14, wherein the fitting part further comprises:
two engagement portions connected to an end of the two joint surfaces away from the turning part, and being configured to fasten the communication base; and
at least one restrictive portion connected to at least one of the two joint surfaces, and adjacent to at least one of the two engagement portions, being configured to prevent the two engagement portions from falling off when fastened to the communication base.

16. The electronic device according to claim 15, wherein the communication base comprises a socket structure configured for the two engagement portions to be fastened.

17. The electronic device according to claim 9, wherein the connection structure is in a shape of lightning.

18. The electronic device according to claim 9, wherein the first distance is between 60 mm and 70 mm.

19. The electronic device according to claim 9, wherein the second distance is between 20 mm and 25 mm.
